(19) United States
(12) Patent Application Publication
(10) Pub. No.: US 2003/0187706 A1
(43) Pub. Date: Oct. 2, 2003

(54) Innovation engine portal method and system

(76) Inventors: Jeffry L. Buchmiller, Pilot Point, TX (US); Curtis J. Connell, Plano, TX (US)

Correspondence Address: BAKER BOTTS L.L.P., 2001 ROSS AVENUE, SUITE 600, DALLAS, TX, 75201-2980, US

(21) Appl. No.: 10/112,412

(22) Filed: Mar. 29, 2002

(51) Int. Cl. G06F 17/60

(52) U.S. Cl. 705/7

(57) ABSTRACT

An enterprise-wide knowledge management system is disclosed, which includes an innovation engine portal that can link each user to any needed expertise, throughout an enterprise, in a consistent manner. As a result, enterprise experts are free to pursue more higher-value-added activities such as, for example, the formation of additional strategic alliances and pursuit of additional mega-deals. As such, in today's “Digital Economy,” a successful organization is enabled to eliminate boundaries, collaborate in new ways, establish trust, and continuously seek improvements. The entire innovation life cycle is made accessible to all employees, from the initial demand for innovation, through the searches for innovation, sparking of innovation creations, innovation collaborations and investments, and innovation reporting and communications. The enterprise-wide knowledge management system provides a system of business processes and tools, which are designed to collect, enhance, and leverage the organization's intellectual capital. The individual efforts to deliver innovative solutions to clients are coordinated into an efficient and effective organization-wide mechanism.

### TECHNICAL FIELD OF THE INVENTION

The present invention relates in general to the knowledge management and innovative services fields and, in particular, but not exclusively, to an innovation engine portal method and system for collecting, supporting, accessing, and leveraging the value of ideas.

### BACKGROUND AND STATE OF THE ART

Many organizations have not institutionalized innovation, or found a way to embed innovation into their cultures and activities. Frequently, in these organizations, new ideas are submitted to managers who have no incentive to develop them. Worse yet, some of these ideas are never brought to the attention of others, so the ideas often wither and die like fruit on the vine. Unfortunately, the loss of such an idea is not recognized by the organization, and as a result, opportunities to develop new strategies, cultures, services, markets, and operating models can be missed without note or comment.

Even when innovators are motivated enough to develop their ideas with little support, it is inherently difficult for them to work within organizations that lack an effective and efficient innovation process. The infrastructure needed to connect innovators both to the demand for innovation and the supporting resources usually does not exist in such organizations. For example, innovators looking for documented expertise on a particular topic have to resort to the use of inefficient search engines which yield average hit counts of thousands per search. In these organizations, those individuals who need innovation can only resort to the use of personal networks and canvassing in order to identify potential sources of new ideas. Those individuals who have ideas are forced to canvass their own personal networks, which often do not overlap with each other in an organization of significant size.

In such an environment, whenever an organization provides an array of services to a wide variety of clients, it is rare that every employee is able to match services with clients effectively. This problem is compounded whenever the services are highly technological and complex in nature. As such, it is very difficult for every employee to keep up to date with the large list of services offered, because the list changes often in response to the rapid pace of change in the technological environment of today's “Digital Economy”. Even with some understanding of the services involved, it is usually not obvious to most employees just what type of client would utilize what service.

In this environment, employees find that they can no longer be self-contained at providing the expertise required to serve their clients properly. There is a significant need for a wide range of expertise to be leveraged into each client's project. The traditional approach of telephoning other employees worked with in the past is no longer viable. A natural first reaction is to telephone a known expert. Consequently, the experts within an organization typically receive numerous telephone calls and emails, which ask for the names of persons who can provide expertise on particular topics. However, a more scalable and efficient mechanism for finding expertise is required.

In order to leverage an organization's accumulated expertise into each client project that needs it, the mechanism for accessing people and documents needs to be enhanced. The particular areas of expertise, training, and experience of each employee need to be made available. The successes and lessons learned from each project need to be documented and stored. The latest technologies, trends, and innovations need to be folded into such a knowledge base.

### SUMMARY OF THE INVENTION

In accordance with the present invention, an enterprise-wide knowledge management system is provided, which includes an innovation engine portal method and system that can link each user to any needed expertise, throughout an enterprise, in a consistent manner. As a result, enterprise experts are free to pursue more higher-value-added activities such as, for example, the formation of additional strategic alliances and pursuit of additional mega-deals. As such, in today's “Digital Economy,” a successful organization needs to be able to eliminate boundaries, collaborate in new ways, establish trust, and continuously seek improvements. The entire innovation life cycle is made accessible to all employees, consisting of the initial demand for innovation, searches for innovation, spark of innovation creation, innovation collaboration and investment, and innovation reporting and communications. The enterprise-wide knowledge management system provides a system of business processes and tools, which are designed to collect, enhance, and leverage the organization's intellectual capital. The individual efforts made to deliver innovative solutions to clients benefit from their coordination into an efficient and effective organization-wide mechanism.

In accordance with one example embodiment of the present invention, the innovation engine portal can provide employees of the organization access to a set of knowledge management tools. These tools are designed to support the delivery of innovative offerings to an organization's clients. A common login to the system can provide access to all of the component tools. The business processes of the innovation life cycle are embedded within these tools. Experts can be brought together who have symbiotic expertise at solving the various problems of, and meeting the various requests made by, the organization and its clients.

For this example embodiment, an innovation engine portal includes four component tools: 1) Idea Workflow Tool; 2) Requests for Innovation; 3) Internal Innovation Index; and 4) External Innovation Index. Essentially, for an organization, there are three primary points of view for users playing the various roles in the business processes involved: innovator; administrator; and manager. Innovators' primary purpose for using a component tool is to promote their own innovative ideas and/or to seek others' innovative ideas with which the innovators can collaborate. Administrators' primary purpose for using a component tool is to facilitate use of a system by others, which can include specifying the system's configuration, making the system available, and ensuring that progress is being made within the processes to develop the ideas involved. Managers' primary purpose for using a component tool is to support their oversight responsibilities. If an organization's innovation initiative includes target metrics for a certain number of ideas of certain types being implemented for clients within a specified period of time, in accordance with this example embodiment, the system can provide suitable reports to serve such needs.

An important technical advantage of the present invention is that organizations can foster innovation and enhance their brands by revealing the nature and scope of innovation that occurs within the organizations to key external audiences. This feature delivers value directly, and also fosters an organizational culture of innovation that leads to additional innovations that, in turn, deliver additional value. To be effective at fostering innovation, the business process can provide an entrepreneurial environment that nurtures and rewards speed, teamwork, and prudent risk-taking.

Another important technical advantage of the present invention is that an innovation engine portal is provided, which includes a set of tools that can implement and support a set of business processes to foster innovation at both the individual and organizational levels. The rewards associated with a successful idea for the idea's originator are significant, both in organization-wide recognition for the innovative effort and monetarily. Because the amount of effort and expertise required for launching a new commercial offering is so large, a successful idea typically has many persons nurturing and developing the idea along the way. As such, the Innovation Engine Portal is a process and system designed primarily to provide access, in a convenient and quick manner, to the people and expertise needed by the idea originator. The process provides a series of funding-related steps that gives idea originators the opportunity to prove their ideas (e.g., even unconventional ideas that have no other chance to be attempted). Such strong encouragement of innovative ideas can involve a higher risk than that for expanding existing capabilities incrementally. However, innovative ideas also have higher differentiation benefits, and disadvantages can be cropped as soon in the process as it is recognized that the ideas are infeasible or do not have the originally intended value. Each of the Innovation Engine Portal's tools has its own value, which can vary according to the tool's alignment with the goals of the organization using the system.

Still another important technical advantage of the present invention is that an idea workflow tool is provided, which ensures that all new ideas and innovations are captured enterprise-wide, and given a fair hearing through a standard process. These new ideas and innovations represent new technologies and business concepts that can maintain an organization in a leadership position into the future. Each idea carries with it the potential for creating new value and differentiation. Also, the existence of an idea workflow tool as an implementation of and idea development process in an organization is visible evidence to all employees that the organization values (and is willing to invest in) innovation.

Yet another important technical advantage of the present invention is that an idea workflow tool can be made available to users on a standard platform such as a web-based intranet or the Internet, at any location around the world and any time of the day. The workflow nature of such an activity enables users to communicate effectively without having to be available to each other at literally the same moment.

Still another important technical advantage of the present invention is that an idea workflow tool can send notification of events within a process to suitable users in the form of configurable communications. For example, such communications can be delivered via a standard email messaging system. Whenever a user logs into the system, the tasks required for that user to perform can be indicated on a local screen to facilitate convenient and prompt actions on the ideas flowing through the workflow process. Administration of an idea workflow tool can be performed with screens associated with that tool, by users assigned privileges based on the role or roles to which they are assigned.

Still another important technical advantage of the present invention is that a request for innovation tool component is included, which provides a convenient, efficient mechanism for connecting the developers of innovative ideas with clients that desire services resulting from those ideas.

Another important technical advantage of the present invention is that an internal innovation index tool is provided, which is designed to provide innovators within an organization ready access to key expertise in a simple and expeditious manner. This feature raises the level of awareness of innovative ideas among the organization's employees. Furthermore, the internal innovation index tool supports the development of nascent ideas while helping to identify opportunities for collaboration. As such, innovators have easy access to previously reviewed high quality information in much less time than previous techniques.

Another important technical advantage of the present invention is that an external innovation index tool is provided, which is designed to provide users outside an organization with ready access to key expertise within the organization in a simple and expeditious manner. This feature raises the level of awareness of an organization's innovative ideas among clients, prospects, partners, investors, analysts, and other parties interested in the organization. The external innovation index tool provides key external audiences with hard evidence of thought leadership and innovation.

Other technical advantages of the present invention will be readily apparent to one skilled in the art from the following figures, description and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates an example system, which can be used to implement an innovation engine portal in hardware and/or software, in accordance with one example embodiment of the present invention;

FIG. 2 illustrates an innovation engine portal process, which may be used to implement an example embodiment of the present invention;

FIGS. 3A and 3B are related diagrams that illustrate an example method for collecting, enhancing, and leveraging innovative ideas, in accordance with one example embodiment of the present invention;

FIG. 4 illustrates an example screen image that can be used to demonstrate key functionality of an innovation engine portal, in accordance with one example embodiment of the present invention;

FIG. 5 illustrates a second example screen image that can be used to demonstrate key functionality of an innovation engine portal, in accordance with one example embodiment of the present invention;

FIG. 6 illustrates a third example screen image that can be used to demonstrate key functionality of an innovation engine portal, in accordance with one example embodiment of the present invention;

FIG. 7 illustrates a fourth example screen image that can be used to demonstrate key functionality of an innovation engine portal, in accordance with one example embodiment of the present invention;

FIG. 8 illustrates a fifth example screen image that can be used to demonstrate key functionality of an innovation engine portal, in accordance with one example embodiment of the present invention;

FIG. 9 illustrates a sixth example screen image that can be used to demonstrate key functionality of an innovation engine portal, in accordance with one example embodiment of the present invention;

FIG. 10 illustrates a seventh example screen image that can be used to demonstrate key functionality of an innovation engine portal, in accordance with one example embodiment of the present invention;

FIG. 11 illustrates an eighth example screen image that can be used to demonstrate key functionality of an innovation engine portal, in accordance with one example embodiment of the present invention; and

FIG. 12 illustrates a ninth example screen image that can be used to demonstrate key functionality of an innovation engine portal, in accordance with one example embodiment of the present invention.

### DETAILED DESCRIPTION OF THE INVENTION

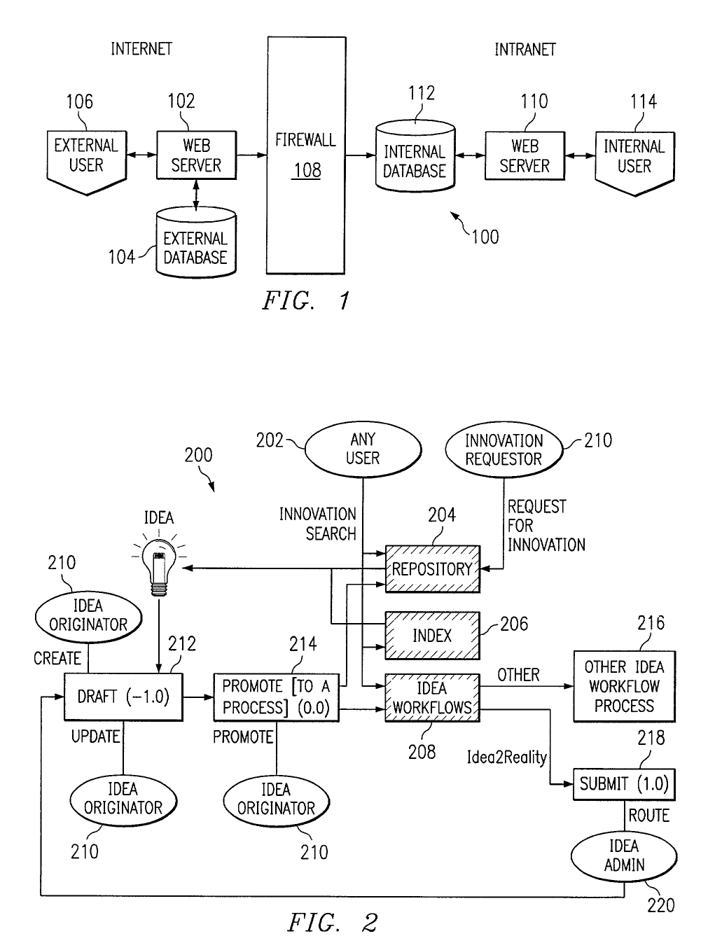

The preferred embodiment of the present invention and its advantages are best understood by referring to FIGS. 1-12 of the drawings, like numerals being used for like and corresponding parts of the various drawings.

FIG. 1 illustrates an example system 100, which can be used to implement an innovation engine portal in hardware and/or software, in accordance with one example embodiment of the present invention. For this example embodiment, system 100 can include a web server 102. Alternatively, for increased performance, system 100 can include a pool of multiple web servers. A primary function of web server 102 (or pool of web servers) is to allow a user 106 to send or receive content over or from the Internet using a standard user interface language such as, for example, the HyperText Markup Language (HTML). Web server 102 can accept a request for content from user 106 via a web browser (e.g., Microsoft Internet Explorer or Netscape Navigator) and return the appropriate HTML documents from an external database 104 or internal database 112 (e.g., through a secure firewall 108 used by the organization involved). For this embodiment, web server 102 can be implemented using a Microsoft Internet Information Server (IIS), which is a high-end, enterprise-level server for Windows NT platforms. Also, for this embodiment, Microsoft's Structured Query Language (SQL) Server can be used as a database server associated with external database 104 or internal database 112. Alternatively, for increased performance, a pool of multiple database servers can be used with external database 104 and/or internal database 112. The Secured HyperText Transfer Protocol (HTTPS) can be used as a secure client-server communications protocol. Certain programming languages and technologies can be used to increase the performance of web server 102, such as for example, Active Server Pages (ASP) and Visual Basic Script (VBScript). The Practical Extraction and Reporting Language (Perl) can be used for batch programs to connect some or all of the above-described components together. The Microsoft Indexing Service (IS) can be used for indexing documents.

Also for this example embodiment, system 100 can include a web server 110. A primary function of web server 110 is to allow a user 112 internal to an organization involved (e.g., enterprise employee) to send or receive content over or from an intranet using a standard user interface language such as, for example, HTML. Web server 110 can accept a request for content from user 114 via a web browser, and return the appropriate documents from internal database 112. Web server 110 can be implemented and function similar to web server 102, as described above. Notably, the above-described technologies can be used to implement at least one example embodiment of the present invention, but the scope of the present invention is not limited by the technologies shown. As such, any suitable technologies can be used to implement an innovation engine portal as a system, method and/or process in hardware and/or software, in accordance with the teachings of the present invention.

As described earlier, for this example embodiment, the innovation engine portal can include the following four components or tools: idea workflow tool; requests for innovation; internal innovation index; and external innovation index. The idea workflow tool, requests for innovation component, and internal innovation index component can reside on web server 110 and a database server (not shown) associated with internal database 112, on the organization's network (e.g., intranet) on the internal side of firewall 108. All internal users (e.g., 114), which can include an organization's employees and other persons authorized to use the organization's network, can access the idea workflow tool, requests for innovation, and internal innovation index components directly. Firewall 108 functions primarily for security purposes to limit network access from one side of the firewall to the other. The external innovation index component can reside on web server 102 and a database server (not shown) associated with external database 104 on the Internet side or external side of firewall 108. An external user 106 (e.g., presumably not an employee or authorized user of the organization's network) can access the external innovation index component directly via the Internet. For implementation, standard technologies can be used where feasible, in order to minimize costs and provide the most flexible and responsive implementation possible within a dynamic business environment. As such, software used for implementing the components of the innovation engine portal can be designed to support a variety of particular idea development processes. However, if a particular set of desired phases, roles, notifications, statuses, etc. differ from the example embodiments described herein, the system administration functionality can be used to reconfigure a particular tool to meet those needs. Also, even within the operating lifecycle of a single process, some reconfiguration of a tool may be performed to reflect the dynamically changing business environment.

In accordance with the present invention, the idea workflow tool component of an innovation engine portal system and method is an execution in technology of one or more workflow-style business processes that can collect, support, and leverage ideas. As described in detail below, an example embodiment of such a process is the Idea2Reality workflow process, which has been developed by Electronic Data Systems, Inc (EDS). The idea workflow tool can support the submission of an idea by an employee anywhere in an organization worldwide, and ensure that the idea is managed appropriately throughout its life cycle. The submission of an idea can be accomplished using a form accessible, for example, through a user's web browser (e.g., assuming that the tool's interface is web-based).

There is a significant amount of effort expended in developing an idea into a well-formed technical and business state that can warrant a new internal service or commercial offering. Normally, an organization cannot afford to allow employees to “play around” with all ideas when there is no assurance that such activities can deliver some value. The ideas that have the most pilot success and effective designs, sufficient scalability, and most efficient delivery of value are adopted as organization-wide solutions and/or are delivered as solutions to the organization's clients. The process inherently prioritizes the ideas on merit, so that those ideas having the highest priority receive the most attention and funding.

If multiple workflow-style business processes are implemented by the same system, the idea workflow tool can track each idea into each process into which the idea has been submitted. As a result, the appropriate administrators and other users can be informed about an idea's progress at the appropriate times. Each separate process may be configured with different users, roles, phases, and so forth. The idea workflow tool can support multiple, collocated processes.

Users who submit ideas can review such information displayed on their home screens in a section entitled “My Ideas”. As such, users can track the status of their ideas within a process, at any time from anywhere in the world. Communications to idea originators, their managers, and others involved in an idea development process can be triggered by changes in a process phase or status. Furthermore, the idea workflow tool can support the administration of an idea, and the management of the idea workflow process. Reports can be provided to reviewers who are assigned by an organization to evaluate the ideas. Each reviewer can have a worklist specific to that user, which shows the actions that user needs to perform. Summary reports and aging reports can also be provided, which can identify those ideas that exceed configured thresholds for aging on a phase-by-phase and status-by-status basis.

The idea workflow tool also provides a tool administrator which can manage communications to users of the tool, assign roles to those users, and control rights to those users through a special selection screen. The system can store user profiles, which enable users to identify and contact each other and thereby foster collaboration. The idea workflow tool can be implemented with standard technologies in a manner that makes it relatively inexpensive for an organization to own and maintain, and is highly configurable to implement quickly any requested changes in the business process(es) being supported.

The requests for innovation tool enables client relationship managers and other client-interfacing employees to enter requests for innovative solutions directly into the innovation engine portal. Any authorized user logged into the system can browse these requests, or locate these requests by keyword lookup searches, by using the internal innovation index tool (as described below). When a user finds a request for an innovative solution that piques that user's interest, suits that user's skills, or matches an innovation that user has developed or envisioned, the requests for innovation tool can be used to list that user as a collaborator on the request. As a result, the requests for innovation tool can make that user's contact information available to the request originator. As a collaborator, that user can also contact the request originator directly. Users who have submitted requests for innovation or listed themselves as collaborators on other requests can view such information listed on their home screen in a section entitled “My Requests”.

The requests for innovation tool can also enable a user who is not an employee of the organization to submit a particular form, in order to make a request for innovation to that organization. For example, such a user can be a current or potential client. This (external) form can be submitted to an employee of the organization. The employee can then submit the external request for innovation into the idea, workflow component of the development process, where the request can be processed in the same manner as internal requests, except that the external user is not allowed to log into the system to view and act on the request directly. In this case, an employee of the organization (e.g., the client relationship manager) who can represent the external user can view and act on this particular request.

The internal innovation index tool is designed to provide innovators within an organization with ready access to key expertise in both a simple and expedited manner. This expertise may reside in documentation, be available through an alliance with an academic institution or strategic partner, or be available from another employee of the organization involved. The internal innovation index may be characterized as being similar to a set of library card catalogs. A user can select a given catalog and search for the needed information within that catalog, or in all of the catalogs.

The internal innovation index tool can maintain information catalogs both manually and automatically. This feature permits the index administrators to ensure that the stored content is of the highest quality and also that it is approved. An example internal innovation index contains one catalog including approximately 450 white papers. A group of organizational leaders referred to as a “Community of Thought Leaders” can approve all new white papers before they are added to the internal innovation index. The internal innovation index can automatically update and fully integrate a first catalog that links to the requests for innovation and another catalog that links to ideas in the organization's overall system. As such, certain indexed content can be hosted and stored within the organization's system, while other indexed content can be hosted and stored elsewhere.

The scope of the internal innovation index is inherently internal to an organization. In other words, any information that is acceptable to show to an internal audience can be included in the internal innovation index, so that search results can span that scope. The scope of the internal innovation index can include information generated within or outside of the organization involved. An administration screen is provided for maintaining an index for all catalogs included in the internal innovation index. For example, the following types of catalogs can be included in an organization's internal innovation index: ideas; requests for innovation; U.S. patents granted to the organization; academic alliances and strategic partnerships; white papers; organization-authored journal articles and conference presentations; and organization-authored books.

The external innovation index can be functionally similar to the internal innovation index. However, the scope of the external innovation index is inherently external to an organization. In other words, any information that is acceptable to show to an external audience can be included in the external innovation index, so that search results can span that scope. The scope of the external innovation index can include information generated within or outside of the organization involved. Notably, it is highly likely that much of the internally generated information within the scope of the internal innovation index does not also reside within the scope of the external innovation index, because an organization's intellectual property is typically safeguarded. Consequently, the administrator of the external innovation index (e.g., an employee of the organization involved) can decide whether none, some, or all of the information in the internal innovation index can be migrated to the external innovation index (e.g., on a document-by-document basis).

FIG. 2 illustrates an innovation engine portal process 200, which may be used to implement an example embodiment of the present invention. For example, process 200 can be implemented using system 100 shown in FIG. 1. Referring to FIGS. 1 and 2, it can be assumed that an employee of an organization has become aware that the innovation engine portal can be used to request a solution from the organization's innovators. Also, the employee knows that a particular client has a problem, and it is likely that the employee's organization can sell that client a solution to that problem if such a solution is available. The employee can login to the organization's network (e.g., intranet) and thereby become a user (e.g., user 114 or 202). The user can perform an innovation search for ideas using an innovation index tool (206), which can form part of the innovation repository (of ideas) 204. The innovation repository 204, which can be stored in the internal database 112, can contain all of the system's (100) innovation-related data that is neither in an idea workflow 208 nor the innovation index 206. As a result of the innovation search, the user may find that a suitable solution exists in the repository 204, and a cross-selling opportunity may arise.

On the other hand, as a result of the search, the user may not find a suitable solution in the repository 204. In that case, the user can become an innovation requester 210 and submit a request for innovation to the repository 204 in database 112 (e.g., via web server 110). As a result of this request for innovation, the user (innovation requester) may receive information and determine that other users have submitted similar requests for solutions to similar problems for other clients. Also, while browsing the results of the innovation search, the user may realize that another known set of documents stored in the internal network may be useful to other users who perform similar searches. The user can recommend to the system administrator that the location of this set of documents be included in the internal innovation index 206.

After considering the innovation search results in more detail, the employee may recognize that a solution can be developed to solve this client's problem, as well as other problems reported in other requests for innovation. Furthermore, this solution may also be valuable to other clients. As such, by returning to use the innovation engine portal (200), the employee can become a user in the role of an idea originator 210. The idea originator 210 can present the idea by answering certain questions on a draft idea submission form 212 (e.g., displayed on a computer monitor). The idea originator can complete the draft form 212 over a period of time (e.g., during research time, breaks, or in between attending to other duties). The draft submission form 212 containing the idea can be updated as needed by the idea originator 210. Once the idea is initially documented (e.g., by completion of the draft idea submission form 212), the idea originator can promote the idea (214) into one of the idea development processes that are available in the organization involved.

An example of such an idea development process is an incubator, which is a process whereby ideas that have not yet matured to the point of demonstrable value can be nurtured. For example, an incubation process may be used if the potential business value or technical value of an idea has not yet been fully developed. Typically, all of the ideas in an incubator are visible to all internal users, so it is likely that someone who can (and is willing to) help develop an idea will do so. Also, in an incubator, multiple partially-formed ideas can be combined into a single complete idea via the collaboration that can occur within such an incubation process.

As mentioned earlier, another example of an idea development process is an EDS Idea2Reality workflow process, which has been developed by EDS and can be used to implement an example embodiment of the present invention. Essentially, an idea workflow development process can begin by having the originator of an idea submit the idea into the organization's idea development workflow. An idea support team can review the idea for completeness, and assign a set of subject matter experts who can assist the originator with refining the idea. Once the idea is completely defined and properly formed, it can be presented to a seed-funding committee for evaluation and prioritization. If the seed-funding committee determines that the idea has merit and a high enough priority, seed funding can be provided. The seed funding can provide the time, money, and other required resources to prove the business opportunity presented by the idea. The results of this “proof-of-concept” effort, which can include, for example, a fully developed business plan, can be presented to a build funding committee. The build funding committee can determine if the idea has ongoing, large-scale merit, and a high enough priority. If so, the build funding committee can provide build funding for the idea. The build funding can provide the time, money, and other required resources needed to build the solution presented by the idea, into its final form. The finalized solution can be integrated into the organization's overall business systems and/or delivered to clients as a commercial offering.

The idea workflow development process can specify that certain employees be involved in meetings to review, discuss, and determine the disposition of ideas currently at their relevant steps of the process. This meeting activity can be supported by the tool involved. Whenever such a meeting is to occur, a user authorized to do so by an assigned role (e.g., an idea administrator), can call up an automated meeting agenda maker feature of the idea workflow development process. This feature can display (e.g., on a screen for the authorized user) all ideas that are in the pre-configured phases and statuses qualifying for a meeting of this type, allow the user to select which items are to be placed on the meeting's agenda, and trigger a notification (e.g., via email) of the agenda to the participants of the meeting. The meeting participants can be determined based on the pre-configured invitee roles for meetings of this type. The user has a link back to a screen (e.g., on a web-based system) which displays the details of the ideas on the agenda for that meeting. Multiple distinct meeting types, with each having its own such phases, statuses, and roles specified by the business process involved, can be configured by an authorized user (e.g., an idea administrator).

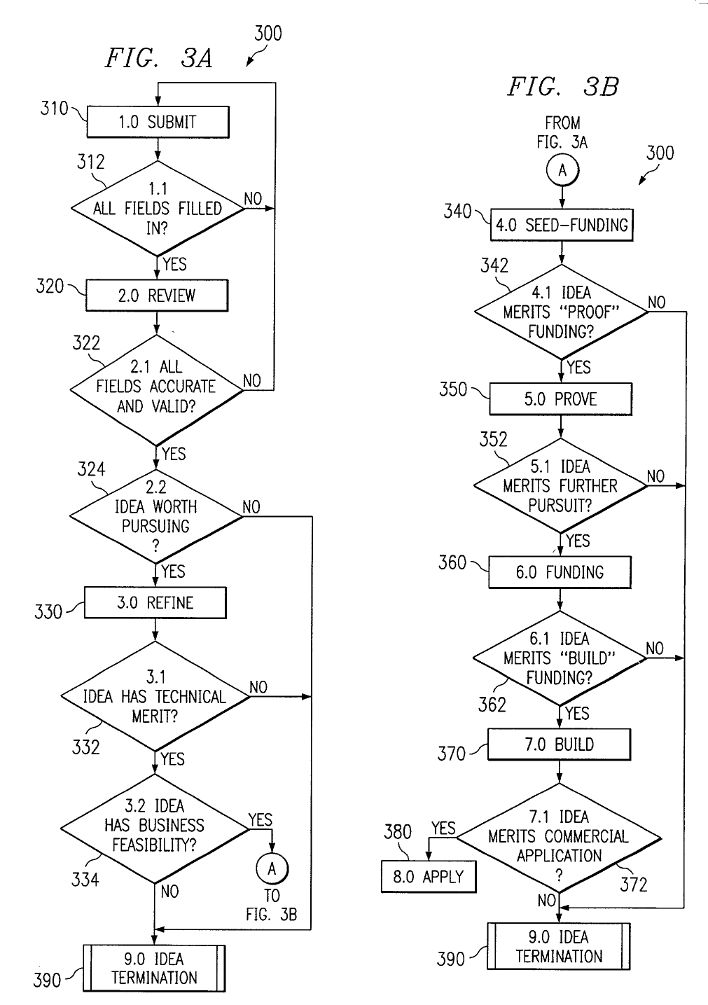

FIGS. 3A and 3B are related diagrams that illustrate an example method 300 for collecting, enhancing, and leveraging innovative ideas, in accordance with one example embodiment of the present invention. For this example embodiment, method 300 can represent the EDS Idea2Reality workflow process mentioned earlier. Also, for this example, method 300 can be implemented by an organization using the example technologies described above with respect to system 100 of FIG. 1. At step 310 in FIG. 3A (e.g., idea submission phase), an originator of an idea (e.g., internal user 114 in FIG. 1) can submit the idea for consideration by an organization, by completing an idea submission form. For example, a pre-defined idea submission form can be displayed on a computer screen, completed by the idea originator, and entered on-line via web server 110. Before the idea is allowed to be submitted to the workf low process, the system can ensure that each field of the form includes some text, and an option has been selected for each multiple-option question.

For example, at step 312, the idea submission form can be reviewed to determine whether or not all of the fields are filled in. Suitable application software running on web server 110 can be used to determine whether or not each field of the idea submission form contains text. If all of the form's fields are not filled in, then returning to step 310, system 100 (e.g., via the application software) can send a suitable message to prompt the idea originator to fill in the missing field(s). The idea originator can save a partially completed version (draft) of the form, and retrieve the form at a later time for further completion.

The idea submission form can be configurable. Standard web form type questions can be included, which can be added, edited, or deleted by a system administrator in order to reflect suitable information to describe an idea for a desired business process involved. As such, system 100 can construct the idea submission form dynamically whenever a user displays a particular screen, in accordance with the configuration desired.

Returning to step 312, if all of the idea submission form's fields are filled in, at step 320 (e.g., idea review phase), one or more persons of an idea development support team can work with the idea originator to ensure that the information in the idea submission form is complete and meaningful, from the standpoint of the organization involved. For example, at step 322, the idea support team can review the idea submission form, and determine whether or not the information contained in each of the form's fields is both accurate and valid (e.g., does not contain random text). If the information in any field of the idea submission form is neither accurate nor valid, then returning to step 310, the idea support team can prompt the idea originator to revise the idea submission form and resubmit it with accurate and valid information.

Otherwise, if at step 322, the idea support team determines that the information in each field of the idea submission form is both accurate and valid, then at step 324, the idea support team can determine whether or not the idea presented in the idea submission form is worth pursuing (e.g., idea describes a capability that falls within the scope of idea development workflow process, or has merit from the supporting organization's point of view). If the idea support team determines that the idea presented in the idea submission form is not worth pursuing, then at step 390, the process of reviewing this particular idea can be terminated. However, if at step 324, the idea support team determines that the idea presented in the idea submission form has merit within the scope of the idea development workflow process involved and is worth pursuing, then the method can proceed to step 330 (e.g., idea refinement phase).

Essentially, some members of the idea development support team can be deemed to be idea administrators. The remaining team members can be deemed to be idea facilitators. The idea administrators can perform step 322 and then assign each completely submitted form to one or more of the idea facilitators to perform step 324 (e.g., working with the idea originator). For example, the idea facilitators can function as process coaches up until the build funding step in the workflow process.

Preferably, the idea administrators and idea facilitators have the ability to transition an idea from one phase or status to the next phase or another status. The system administrator can configure notifications of these events to be triggered in accordance with predetermined definitions of the particular business process involved. A correspondence template can be configured with “smart tags” for any desired phase or state transitions, with the smart tags representing data fields associated with each idea (e.g., idea originator's name, idea facilitator's name, idea identification number, idea submission date, etc.). The roles of the individuals to which each of the notifications are to be sent can also be configured. Whenever a phase or status transition is initiated for an idea, any correspondence that is triggered as a notification message is presented to the user for editing and approval. After the user indicates acceptance of the pending transition, system 100 can initiate the transition for that idea and send out the resulting correspondence (e.g., via email) to the intended recipients.

The idea administrators can have the ability to administer the roles of the various users of system 100. If a new role is added to the workflow process (e.g., idea facilitator, subject matter expert, seed funding committee member, or other suitable role), the idea administrators can assign the proper role to the new user, so that the new user can access the needed functionality (e.g., using a browser on a suitable screen) for the particular role involved. Notably, the roles assigned to users may be altered by the idea administrators as desired to support the different business processes involved. Also, the functionality associated with each role can be reconfigured by the idea administrators as desired.

The idea administrators and idea facilitators can have the ability to associate particular users with particular ideas. For example, the idea originator and idea administrators can be automatically assigned as contacts for a particular idea. Thereafter, an idea administrator can assign idea facilitators as contacts for the idea, and the idea facilitators can assign subject matter experts, seed funding committee members, and so on, as contacts for that idea. As such, in order for a user to be able to access the specific functionality for an idea, the user can be required to have the proper role and also be specified as a contact for that idea. For example, a user having the role of a subject matter expert can be allowed to view all ideas and add comments to each subject matter expert folder associated with each idea. Notably, a “folder” is a labeled unit of storage on a database system that can store comments made by users and documents uploaded by users. On the other hand, an idea facilitator can be allowed only to transition an idea from one status to another (e.g., after being specified by an idea administrator as a contact for that idea). For increased flexibility, a user can specify that a particular piece of correspondence not be sent out for a particular phase change or status change (e.g., if the system is being updated off-line), or that a particular piece of correspondence be sent out at any time (e.g., to send out another copy of the correspondence). Each user designated as a contact for an idea can have the ability to review all details of that idea, which can include, for example, the submission date, responses to the questions on the idea submission form, and the contents of any folders associated with that idea.

As such, each idea being processed (e.g., through the example EDS Idea2Reality workflow described herein) can have a configured set of process folders associated with that idea. The contents of each such folder can be manually or automatically created. For example, a suitable comment can be added to the process folder for an idea, whenever a notification message is triggered by a phase change or status change. Whenever correspondence is sent out for a particular idea, a copy of that correspondence can be stored in a process folder for that idea. Any user who is identified as a contact for an idea can add comments to and upload documents into a process folder for that idea (e.g., to which that user is authorized access). All public folders and process folders associated with an idea can be made available to all users who are designated as contacts for that idea. A user designated as an idea contact and assigned the role of a subject matter expert for that idea can access any subject matter expert folder associated with that idea. Notably, for added flexibility, other folders and access roles can be configured to meet the various requirements for collaboration on the development of an idea across an organization (e.g., with or without tighter role-based restrictions imposed on the folders' contents).

Returning to the idea refinement phase at step 330, the submitted idea can be assessed by a team of subject matter experts to determine whether or not that idea has technical merit. If the submitted idea is deemed by the subject matter experts to have technical merit, then at step 334, the experts can determine whether or not the idea is feasible from a basic business standpoint for the organization involved. Otherwise, if the subject matter experts determine that the submitted idea neither has technical merit nor is feasible (steps 332, 334), then at step 390, the process of refining this particular idea can be terminated.

Returning to step 334, if the subject matter experts determine that the submitted idea is feasible, then the method can proceed to step 340 (e.g., seed funding phase) in FIG. 3B. At step 340, the details of the idea can be presented to a review committee. At step 342, the review committee can determine whether or not to fund the submitted idea for “proof-of-concept” development. The “proof-of-concept” development effort can be large enough to be difficult for the idea originator to perform in addition to normally assigned day-to-day duties, but small enough to minimize the resources expended to prove that the idea works and can do so in a manner that is efficient enough to be worthwhile on a large scale. Part of the benefit derived from using this centralized funding is that it can avoid having the idea originator impose the cost, time, and other resources needed solely on the idea originator's own department. Such impositions often stifle ideas for reasons not related to their true value to the organization involved.

At step 342, if the review committee determines that the submitted idea should be funded, then the method can proceed to step 350 (e.g., prove phase). Otherwise, if the review panel determines that the idea should not be given seed funding, then at step 390, the concept development process for the submitted idea can be terminated.

At step 350, using the seed funding provided, the originator of the idea can develop the idea into a proof-of-concept. At step 352, the review committee can determine whether or not the proof-of-concept provides sufficient evidence that the idea warrants further development. If (e.g., after learning about the idea's characteristics in the proof-of-concept development) the review committee determines that the idea should be developed further, then the method can proceed to step 360 (e.g., build funding phase). Otherwise, at step 390, the process of proving the concept for the submitted idea can be terminated.

At step 360, the developed idea can be presented to a review panel for consideration of build funding. Typically, build, funding provides significantly greater resources than that provided by seed funding. However, the build funding allows the development of a significantly greater process, functionality, and planning for the idea involved (e.g., up to the point where the idea can be delivered in a production-ready mode to the organization and/or as a commercial offering to the organization's clients. At step 362, the review panel can determine whether or not the idea has enough merit to provide build funding. If the review panel decides to continue funding the idea, then the method proceeds to step 370 (e.g., idea build phase). Otherwise, at step 390, the process of funding the submitted idea can be terminated.

At step 370, in the idea build phase, the idea originator can attempt to fully develop the submitted idea into a commercial offering or other production service or product useful to the organization. At step 372, the review panel can determine whether or not the idea has successfully developed into a viable commercial offering. If the review panel determines that the idea has been successfully developed into a viable commercial offering or other useful production service or product, then the method can proceed to step 380 (e.g., idea apply phase). Otherwise, at step 390, the process of building the idea into a commercial offering can be terminated. During the idea apply phase, the development can be managed long-term by individuals who may or may not have been involved with the idea's development up to that point.

Notably, throughout the idea development workflow process (e.g., the EDS Idea2Reality workflow process described above), the process participants and managers of the organization involved are typically interested in the details of the activities occurring in the process. System 100 can provide suitable reports with pertinent information, such as for example, the number of ideas currently in each phase and/or status, the number of ideas that have reached each phase, the number of ideas submitted per month on a historical basis, the number of active ideas per geographical region, etc. An Idea Aging Report can be useful for judging the overall health of the idea development workflow process. For example, each idea that is in a particular phase or status for which an acceptable time delay has been configured, can be shown in an aging report as a line item in a summary format, along with a colored icon (e.g., red, yellow, or green). A red icon can indicate that the acceptable time delay for a particular phase or status has been exceeded. A yellow icon can indicate that a red icon's condition has occurred, but an idea administrator has over-ridden the acceptable time delay, and the new time delay has not yet been exceeded. A green icon can indicate that the original acceptable time delay has not been exceeded. The portion of each colored icon appearing on the Idea Aging Report can indicate whether the participants in the idea development process are acting promptly (e.g., relative to configured standards).

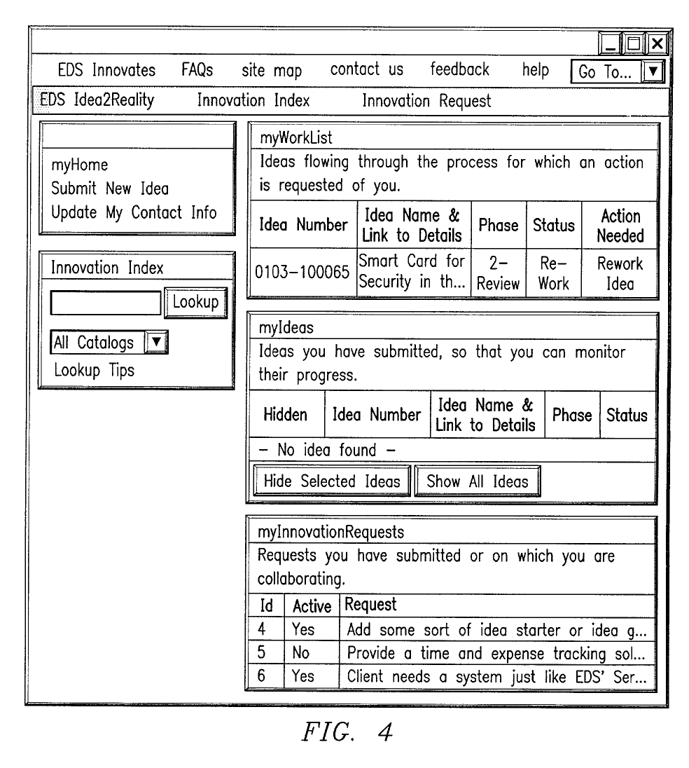

FIG. 4 illustrates an example screen image that can be used to demonstrate key functionality of an innovation engine portal, in accordance with one example embodiment of the present invention. This example screen image can represent a “myHome” screen for a typical idea originator. As such, the topmost menu bar is a common menu bar for all of the tools associated with the innovation engine portal. The second menu bar can provide quick access to each component of the innovation engine portal other than the external innovation index. The external innovation index is not needed on the organization's internal network because it is redundant to the internal innovation index. The user's EDS Idea2Reality menu appears in the upper left section of the screen below the menu bars. Any idea that has an action pending by this user is displayed in the “myWorklist” section. Such an idea has a link to the action that is required next by the process. These ideas may include the originator's own idea (e.g., as in this case when it needs reworking), or they may be other originators' ideas at a step in the process that requires the attention of an idea administrator, idea facilitator, subject matter expert, or other role that this user plays in the process. The ideas that this user originated, which are in the process in someone else's worklist, appear in the “myIdeas” section of the screen, so that the idea originator user can monitor them.

The EDS Idea2Reality workflow tool functions as a portal, so this initial “myHome” screen can also include quick access to the most significant feature of each of the requests for innovation tool and the internal innovation index tool. As such, the internal innovation index lookup box is at the left side of this screen, and this box functions just as it does when the user explicitly visits the internal innovation index component. The “myInnovationRequests” section of the screen provides a quick summary of all requests for innovation that this user either has initiated or is collaborating on.

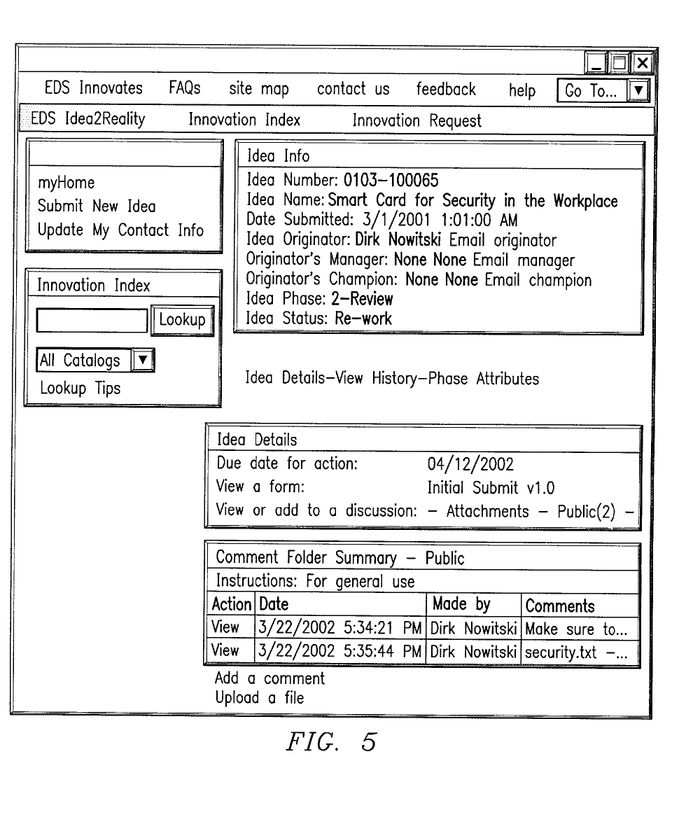

FIG. 5 illustrates a second example screen image that can be used to demonstrate key functionality of an innovation engine portal, in accordance with one example embodiment of the present invention. This example screen image can represent an “Idea Details” screen. For example, whenever the user follows the link for a particular idea on the “myHome” screen (FIG. 4), the “Idea Details” screen is displayed, which can provide access to the idea's submission form, its folders, the history of the idea submission form's phase and status transitions, and any data attributes that are associated with a phase or status, such as Seed Funding Priority for the Seed Funding phase. Also, this screen can be used to add comments and upload files to the idea's folders. The idea administrator and idea facilitator users have additional features available whenever they view this screen. Also, the idea administrator and facilitator have access to more folders and additional features via this screen, such as for example, the “Change Phase” or “Change Status”, “Update Idea Contacts”, etc.

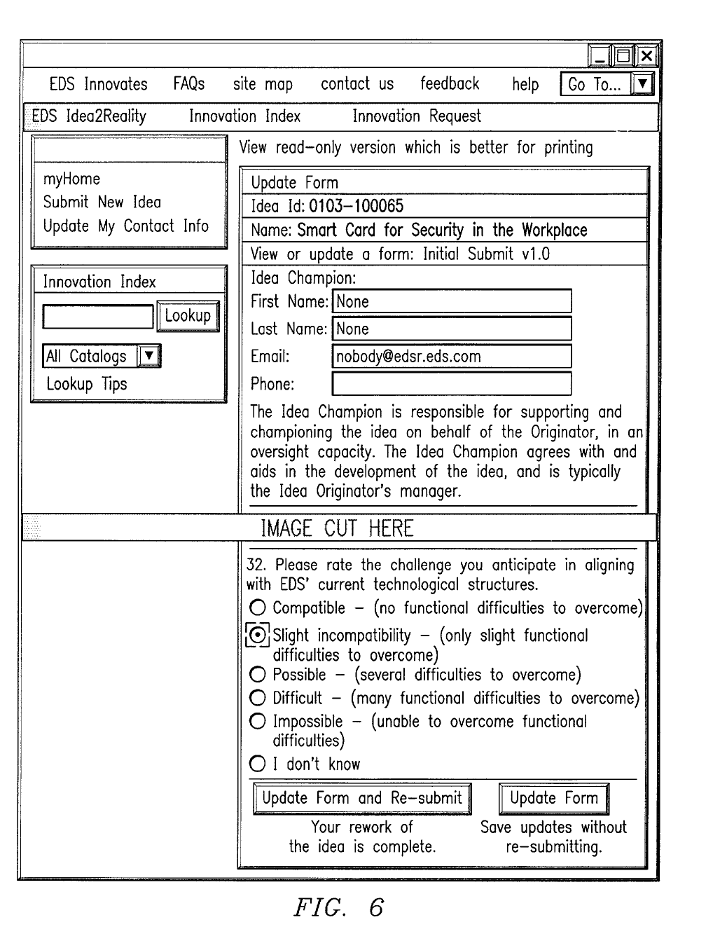

FIG. 6 illustrates a third example screen image that can be used to demonstrate key functionality of an innovation engine portal, in accordance with one example embodiment of the present invention. This example screen image can represent an “Update Idea” screen. For example, the action that was required next for the idea on this user's “myHome” screen (FIG. 4) was to rework the idea via the “Update Idea” screen. The responses that had been provided to the questions presented when the idea was submitted can be recalled and displayed, with the option available to update all or any of the responses. The “Image Cut Here” bar represents a shortening of the actual screen image, for clarity purposes. Each question on the idea submission form can be configurable, so the additional questions not shown on the shortened screen image are not significant. Once the user has completed making updates to the form (using this screen), the “Update Form and Re-submit” button can be pressed to re-submit the form back to the phase and status in the process from which the form came.

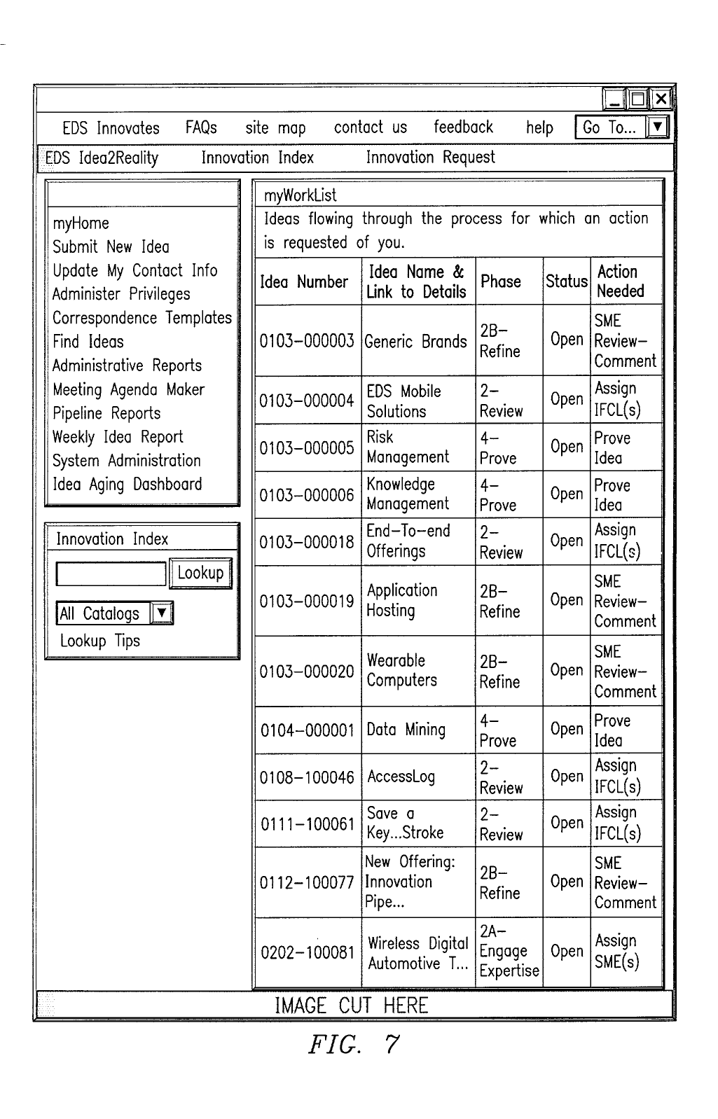

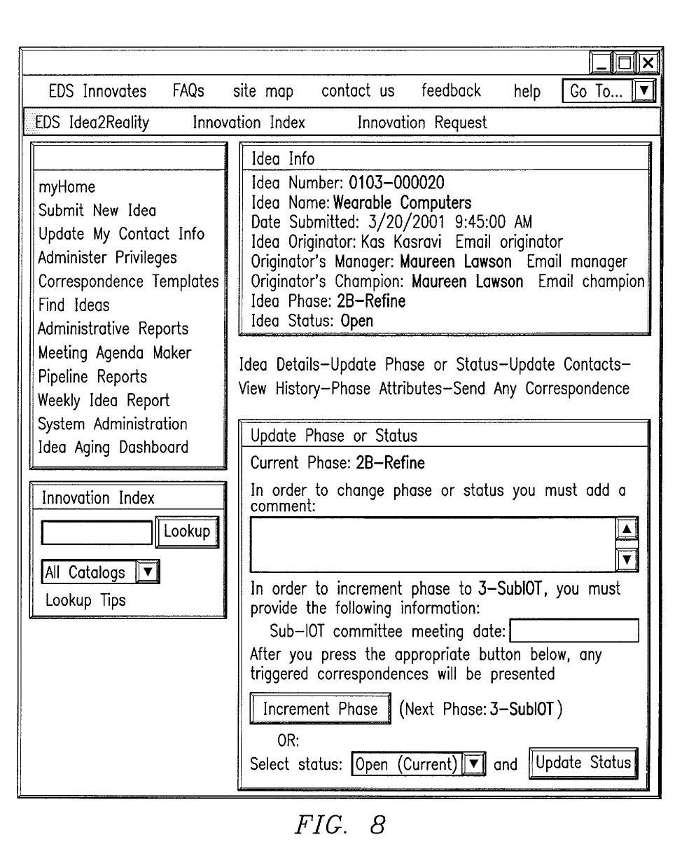

FIG. 7 illustrates a fourth example screen image that can be used to demonstrate key functionality of an innovation engine portal, in accordance with one example embodiment of the present invention. This example screen image can represent a “myHome” screen for use by a system administrator. For example, the “myHome” screen for a system administrator can indicate additional functionality of the example tool in the EDS Idea2Reality menu. This screen can also indicate that several ideas with pending actions are in the process in various phases and statuses. The remainder of this screen (not shown) is analogous to the “myHome” screen for an idea originator (FIG. 4).

FIG. 8 illustrates a fifth example screen image that can be used to demonstrate key functionality of an innovation engine portal, in accordance with one example embodiment of the present invention. This example screen image can represent a “Change Phase or Status” screen for use by an idea facilitator. For example, the idea facilitator assigned to an idea can have this additional functionality available when viewing an “Idea Details” screen (FIG. 5). The system administrator typically has access to all system functionality in order to verify that the system is operating properly whenever needed, and this screen image represents such a user, the EDS Idea2Reality menu on the left side of the screen displays more options than provided for a typical idea facilitator. This screen can be displayed when the “Update Phase or Status” link is followed from any of the “Idea Details” screens (FIG. 5). The comment provided here by the idea facilitator via this screen is placed in a Process folder. The phase attribute value provided here is required because the “Sub-IOT” committee meeting date attribute is associated with the next phase (e.g., “3-SubIOT”). The user can then click on the “Increment Phase” button to proceed to edit any triggered correspondences that serve as email message notifications to users associated as contacts for this idea. Similarly, if the user selects a new status and clicks on the “Update Status” button, the triggered correspondences can be presented. After the user reviews and edits any correspondences, the user can then finalize the change, which can include the system sending the related correspondences to the configured user via any available mail system.

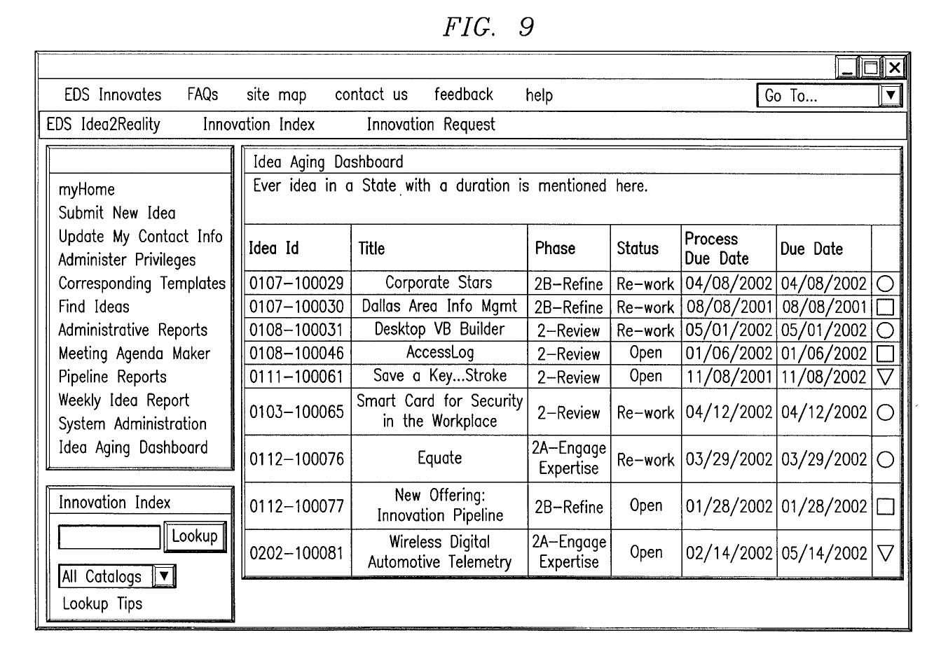

FIG. 9 illustrates a sixth example screen image that can be used to demonstrate key functionality of an innovation engine portal, in accordance with one example embodiment of the present invention. This example screen image can represent an “Idea Aging Dashboard” report screen. For example, this report can show which ideas are overdue for a pending action (as described earlier).

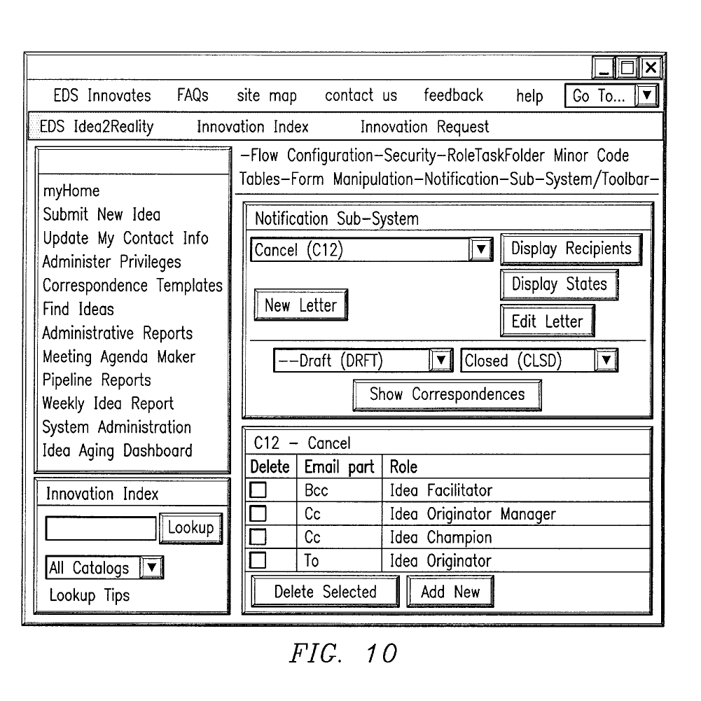

FIG. 10 illustrates a seventh example screen image that can be used to demonstrate key functionality of an innovation engine portal, in accordance with one example embodiment of the present invention. This example screen image can represent a “System Configuration” screen for a system administrator. For example, this screen is one of the screens that can be used by a system administrator user to configure the behavior of the system according to the desired idea development workflow and associated rules. Each system configuration screen shows the categories of system configuration that are supported. This particular screen shows the set of roles to which this correspondence (e.g., “C12-Cancel”) can be sent via email, and in which addressee category, “To”, “Cc”, or “Bcc”. Contacts of the idea who are playing these roles can be sent this correspondence whenever it is triggered as a notification due to a change in the idea's phase or status.

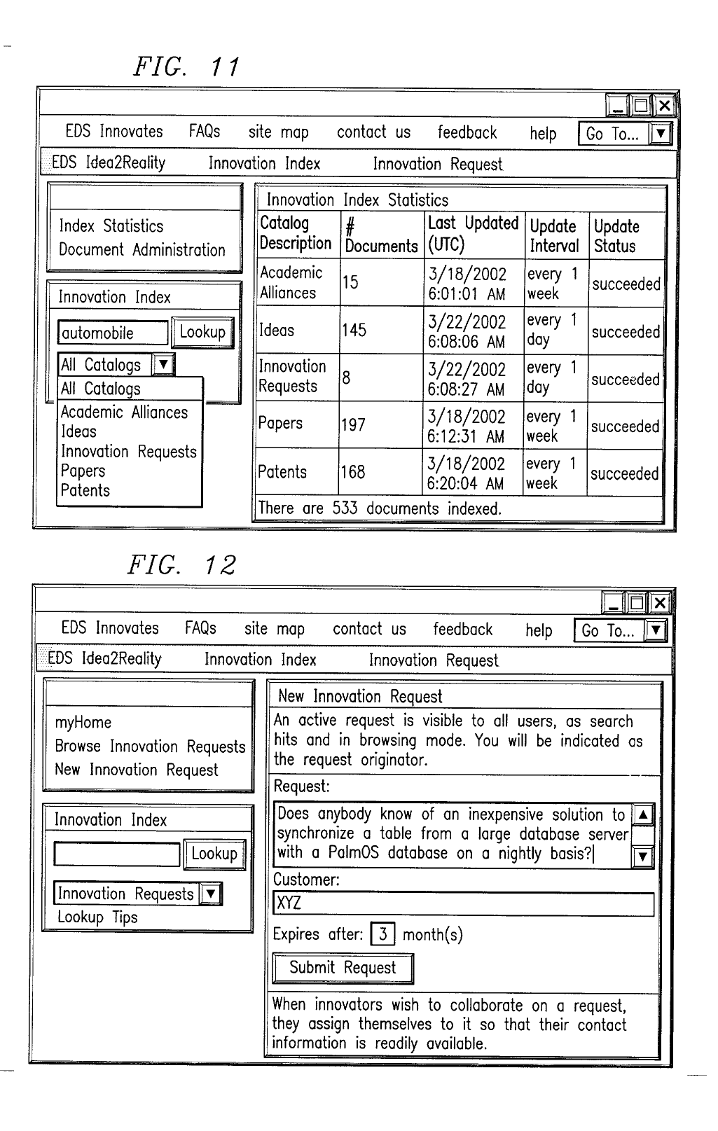

FIG. 11 illustrates an eighth example screen image that can be used to demonstrate key functionality of an innovation engine portal, in accordance with one example embodiment of the present invention. This example screen image can represent an “Innovation Index” tool screen. For example, this component of the system can be available to all users. The Innovation Index lookup form is displayed on the left side of the screen. The drop-down menu of catalogs that were available at that time is shown expanded. The user may select a particular catalog, or all catalogs at once. The user provides a search string in the text box, and then clicks on the “Lookup” button. Hidden (temporarily) by the expanded catalogs menu is a link to the “Lookup Tips” screen, which explains how to use the advanced lookup capabilities such as, for example, wildcards and Boolean logic. The “Document Administration” menu item is available to the index administrator, and it is where documents can be added to, updated, and removed from catalogs. A typical idea originator user does not have access to this screen. When the user selects the “Innovation Index” component in the second menu bar, as opposed to using the “Innovation Index” lookup form displayed directly on the EDS Idea2Reality screens, the system displays a summary of the various defined catalogs. The update intervals are configurable on the “Document Administration” screen. The batch program that actually prepares the documents for indexing can be implemented with the Perl language. The Microsoft IS technology requires that a copy of a remote web-based document be cached locally. As a result, such a batch program is required to support this requirement. If an alternative indexing service is utilized, then this batch program is likely not needed. The Microsoft IS makes the status of each of its catalogs available to the system, which status is displayed on this screen to ease index administration.

FIG. 12 illustrates a ninth example screen image that can be used to demonstrate key functionality of an innovation engine portal, in accordance with one example embodiment of the present invention. This example screen image can represent a “Requests for Innovation” tool screen. For example, the “Requests for Innovation” tool allows any user to submit requests for innovation. Each request includes a customer name and associated expiration time delay. The request initiator can update or deactivate the request as needed via buttons that appear on the “View Request” page whenever they are appropriate, according to this particular request and user and to the processing rule. The summary of active requests is available via the “Browse Innovation Requests” menu item, and it appears the same as the “myInnovationRequests” section of the user's “myHome” page, though with all users' active requests displayed instead of just those of this user. Clicking on any particular request takes the user to the “View Request” page, where a button is available to add the user to the request in the role of collaborator. All other users can see which users have added themselves as collaborators.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A method for collecting, supporting, accessing, or leveraging the value of ideas, comprising the steps of:
storing a plurality of digital files in an idea repository, each file of said plurality of digital files including data associated with at least one respective idea;
maintaining an index for said idea repository, said index including a plurality of categories, each category of said plurality of categories including data associated with a respective subset of said plurality of digital files; and
enabling a search of said idea repository for at least one idea, said search including at least one category of said plurality of categories.

2. The method of claim 1, wherein said idea repository comprises an internal database.

3. The method of claim 1, wherein said idea repository comprises an external database.

4. The method of claim 1, wherein said search is performed within an organization's internal network.

5. The method of claim 1, wherein said search is performed via an Internet web page.

6. The method of claim 1, wherein said search comprises a request for an innovative solution.

7. A method for collecting, supporting, accessing, or leveraging the value of ideas, comprising the steps of:
submitting an idea in a digital form to an automated idea development process;
determining if said submitted idea represents sufficient short-term value for initial development;
if said submitted idea is determined to represent sufficient short-term value for initial development, initiating a proof-of-concept development phase in said automated idea development process for said submitted idea;
if said submitted idea is determined not to represent sufficient short-term value for initial development, terminating said automated idea development process for said submitted idea;
if said proof-of-concept development phase is initiated for said submitted idea, determining if a result of said proof-of-concept development phase indicates that said submitted idea represents sufficient long-term value for build development;
if said submitted idea is determined to represent sufficient long-term value for build development, initiating a build development phase in said automated idea development process for said idea;
if said submitted idea is determined not to represent sufficient long-term value for build development, terminating said automated idea development process for said submitted idea;
if said build development phase is initiated, determining if a result of said build development phase indicates that said submitted idea represents sufficient commercial value; and
if said result of said build development phase indicates that said submitted idea does not represent sufficient commercial value, terminating said automated idea development process for said submitted idea.

8. The method of claim 7, further comprising the steps of:
determining if said digital form is complete; and
if said digital form is determined not complete, prompting an idea submitter to complete said digital form.

9. The method of claim 7, further comprising the step of:
if said result of said build development phase indicates that said submitted idea represents sufficient commercial value, initiating an idea commercial application phase in said automated idea development process for said submitted idea.

10. The method of claim 7, wherein each step is performed using a web browser coupled to a web page.

11. The method of claim 7, wherein said automated idea development process is implemented in software residing in a web server.

12. The method of claim 7, wherein said method is implemented in software residing in a network server.

13. A system for collecting, supporting, accessing, or leveraging the value of ideas, comprising:
a digital processing unit; and
a data storage unit coupled to said digital processing unit, said data storage unit including an idea repository, and said digital processing unit and said data storage unit in combination operable to:
store a plurality of digital files in said idea repository, each file of said plurality of digital files including data associated with at least one respective idea;
maintain an index for said idea repository, said index including a plurality of categories, each category of said plurality of categories including data associated with a respective subset of said plurality of digital files; and
enable a search of said idea repository for at least one idea, said search including at least one category of said plurality of categories.

14. The system of claim 13, wherein said idea repository resides in an internal database.

15. The system of claim 13, wherein said idea repository resides in an external database.

16. The system of claim 13, wherein said search is performed within an organization's internal network.

17. The system of claim 13, wherein said search is performed via an Internet web page.

18. The system of claim 13, wherein said search comprises a request for an innovative solution.

19. A system for collecting, supporting, accessing, or leveraging the value of ideas, comprising:
a digital processing unit; and
a data storage unit coupled to said digital processing unit, said digital processing unit and said data storage unit in combination operable to:
submit an idea in a digital form to an automated idea development process;
if a reviewer determines that said submitted idea represents sufficient short-term value for initial development, initiate a proof-of-concept development phase in said automated idea development process for said submitted idea;
if said submitted idea is determined not to represent sufficient short-term value for initial development, terminate said automated idea development process for said submitted idea;
if a reviewer determines that a result of said proof-of-concept development phase indicates that said submitted idea represents sufficient long-term value for build development; initiate a build development phase in said automated idea development process for said idea;
if said submitted idea is determined not to represent sufficient long-term value for build development, terminate said automated idea development process for said submitted idea; and
if a reviewer determines that a result of said build development phase indicates that said submitted idea represents sufficient commercial value, initiate a commercial application phase in said automated idea development process for said submitted idea; and
if said submitted idea is determined not to represent sufficient commercial value, terminate said automated idea development process for said submitted idea.

20. The system of claim 19, said digital processing unit and data storage unit further operable to:
determine if said digital form is complete; and
if said digital form is determined not complete, prompt an idea submitter to complete said digital form.

21. The system of claim 19, wherein said digital processing unit comprises a web server.

22. The system of claim 19, wherein said digital processing unit comprises a network server, and said data storage unit comprises a database.

23. A system for collecting, supporting, accessing, or leveraging the value of ideas, comprising:
means for storing a plurality of digital files in an idea repository, each file of said plurality of digital files including data associated with at least one respective idea;
means for maintaining an index for said idea repository, said index including a plurality of categories, each category of said plurality of categories including data associated with a respective subset of said plurality of digital files; and
means for enabling a search of said idea repository for at least one idea, said search including at least one category of said plurality of categories.

24. A system for collecting, supporting, accessing, or leveraging the value of ideas, comprising:
means for submitting an idea in a digital form to an automated idea development process;
means for determining if said submitted idea represents sufficient short-term value for initial development;
means for initiating a proof-of-concept development phase in said automated idea development process for said submitted idea, if said submitted idea is determined to represent sufficient short-term value for initial development;
means for terminating said automated idea development process for said submitted idea, if said submitted idea is determined not to represent sufficient short-term value for initial development;
means for determining if a result of said proof-of-concept development phase indicates that said submitted idea represents sufficient long-term value for build development, if said proof-of-concept development phase is initiated for said submitted idea;
means for initiating a build development phase in said automated idea development process for said idea, if said submitted idea is determined to represent sufficient long-term value for build development;
means for terminating said automated idea development process for said submitted idea, if said submitted idea is determined not to represent sufficient long-term value for build development;
means for determining if a result of said build development phase indicates that said submitted idea represents sufficient commercial value, if said build development phase is initiated; and
means for terminating said automated idea development process for said submitted idea, if said result of said build development phase indicates that said submitted idea does not represent sufficient commercial value.

25. Software for collecting, supporting, accessing, or leveraging the value of ideas, the software embodied in computer-readable media and when executed operable to:
store a plurality of digital files in an idea repository, each file of said plurality of digital files including data associated with at least one respective idea;
maintain an index for said idea repository, said index including a plurality of categories, each category of said plurality of categories including data associated with a respective subset of said plurality of digital files; and
enable a search of said idea repository for at least one idea, said search including at least one category of said plurality of categories.

26. Software for collecting, supporting, accessing, or leveraging the value of ideas, the software embodied in computer-readable media and when executed operable to:
submit an idea in a digital form to an automated idea development process;
determine if said submitted idea represents sufficient short-term value for initial development;
initiate a proof-of-concept development phase in said automated idea development process for said submitted idea, if said submitted idea is determined to represent sufficient short-term value for initial development;
terminate said automated idea development process M for said submitted idea, if said submitted idea is determined not to represent sufficient short-term value for initial development;
determine if a result of said proof-of-concept development phase indicates that said submitted idea represents sufficient long-term value for build development, if said proof-of-concept development phase is initiated for said submitted idea;
initiate a build development phase in said automated idea development process for said idea, if said submitted idea is determined to represent sufficient long-term value for build development;
terminate said automated idea development process for said submitted idea, if said submitted idea is determined not to represent sufficient long-term value for build development;
determine if a result of said build development phase indicates that said submitted idea represents sufficient commercial value, if said build development phase is initiated, and
terminate said automated idea development process for said submitted idea, if said result of said build development phase indicates that said submitted idea does not represent sufficient commercial value.
